(19) United States
(12) Patent Application Publication
(10) Pub. No.: US 2026/0058366 A1
(43) Pub. Date: Feb. 26, 2026

(54) METASURFACE UNIT, AND METASURFACE ARRAY ANTENNA AND COMMUNICATION APPARATUS CONTAINING SAME

(71) Applicant: BEIJING XIAOMI MOBILE SOFTWARE CO., LTD., Beijing (CN)

(72) Inventors: Liangang CHI, Beijing (CN); Dong CHEN, Beijing (CN)

(73) Assignee: BEIJING XIAOMI MOBILE SOFTWARE CO., LTD., Beijing (CN)

(21) Appl. No.: 19/103,266

(22) PCT Filed: Aug. 15, 2022
(86) PCT No.: PCT/CN2022/112613

§ 371 Date: Feb. 12, 2025

(51) Int. Cl. H01Q 3/46; H01Q 1/24; H01Q 15/24; H01Q 19/10

(52) U.S. Cl. CPC H01Q 3/46; H01Q 1/243; H01Q 15/24; H01Q 19/10

(57) ABSTRACT

Disclosed in the embodiments of the present application are a metasurface unit, and a metasurface array antenna and a communication device containing same. The metasurface unit includes a first-layer dielectric plate, a second-layer dielectric plate and a third-layer dielectric plate, wherein the second-layer dielectric plate includes a metal grounding layer, a liquid-crystal material layer, a metal patch having anisotropic characteristics, and a direct-current bias line, and both the direct-current bias line and the metal patch are printed on the liquid-crystal material layer; and the first-layer dielectric plate is one surface of the metasurface unit, the third-layer dielectric plate is another surface of the metasurface unit, and the second-layer dielectric plate is located between the first-layer dielectric plate and the third-layer dielectric plate.

### CROSS-REFERENCE TO RELATED APPLICATIONS

This application is a U.S. National Phase of International Application No. PCT/CN2022/112613, filed with the State Intellectual Property Office of P. R. China on Aug. 15, 2022, the entire contents of which are incorporated herein by reference.

### TECHNICAL FIELD

The disclosure relates to a field of communication technology, in particular to a metasurface unit, a metasurface array antenna and a communication device thereof.

### BACKGROUND

In related technologies, a reconfigurable metasurface can be realized by incorporating adjustable components and materials such as diodes into units of a metasurface antenna in conjunction with a high or low bias voltage. To create a metasurface that is capable of dual-frequency operation, a metasurface having a dual-frequency operating capability is constructed by adding photodiodes or varactor diodes in two polarization directions of the units, changing an operating state of the diodes, and controlling unit phase response of the units in the polarization direction (frequency band). However, the existing technical solutions have high costly and high loss, and most of the photodiodes and varactor diodes cannot operate at millimeter-wave frequency band.

### SUMMARY

According to a first aspect of embodiment of the disclosure, a metasurface unit is provided. The metasurface unit includes:
a first-layer dielectric plate, a second-layer dielectric plate and a third-layer dielectric plate, in which the second-layer dielectric plate includes a metal grounding layer, a liquid-crystal material layer, a metal patch with anisotropic characteristics and a direct-current (DC) bias line, the DC bias line and the metal patch are both printed on the liquid-crystal material layer, the first-layer dielectric plate is one surface of the metasurface unit, the third-layer dielectric plate is the other surface of the metasurface unit, and the second-layer dielectric plate is located between the first-layer dielectric plate and the third-layer dielectric plate.

According to a second aspect of embodiment of the disclosure, a metasurface array antenna is provided. The metasurface array antenna includes the metasurface unit described in the first aspect.

According to a third aspect of embodiment of the disclosure, a communication device is provided. The communication device has the metasurface array antenna described in the second aspect.

### BRIEF DESCRIPTION OF THE DRAWINGS

In order to clearly illustrate technical solutions of embodiments of the disclosure or background technologies, a description of drawings used in the embodiments or the background technologies is given below.

FIG. 1 is a schematic diagram illustrating a communication system provided by an embodiment of the disclosure.

FIG. 2 is a schematic diagram illustrating a side view of a metasurface unit provided by an embodiment of the disclosure.

FIG. 3 is a schematic diagram illustrating a top view of a metasurface unit provided by an embodiment of the disclosure.

FIG. 4 is a schematic diagram illustrating the connection of metasurface units in the same column provided by an embodiment of the disclosure.

FIG. 5 is a simulation curve graph showing the reflection amplitude and reflection phase of the metasurface unit as a function of frequency.

FIG. 6 is a schematic diagram illustrating an arrangement of metasurface units in the case of incidence with a first polarization wave.

FIG. 7 is a schematic diagram illustrating an arrangement of metasurface units in the case of incidence with a second polarization wave.

FIG. 8a is a two-dimensional far-field radiation pattern of the metasurface units realizing beam scanning at 31.5 GHz.

FIG. 8b is a two-dimensional far-field radiation pattern of the metasurface units realizing beam scanning at 42.2 GHz.

FIG. 9 is a schematic diagram illustrating a metasurface array antenna provided by an embodiment of the disclosure.

FIG. 10 is a schematic diagram illustrating a communication device provided by an embodiment of the disclosure.

### DETAILED DESCRIPTION

Reference will now be made in detail to embodiments, examples of which are illustrated in the accompanying drawings. The following description refers to the accompanying drawings in which the same numbers in different drawings represent the same or similar elements unless otherwise represented. The implementations set forth in the following description of embodiments do not represent all implementations consistent with the embodiments of the disclosure. Instead, they are merely examples of apparatuses and methods consistent with aspects related to the disclosure as recited in the appended claims.

The terms used in the embodiments of the disclosure are only for the purpose of describing specific embodiments, and are not intended to limit the embodiments of the disclosure. The singular forms of “a” and “the” used in the disclosure and appended claims are also intended to include plural forms, unless the context clearly indicates other meanings. It is understandable that the term “and/or” as used herein refers to and includes any or all possible combinations of one or more associated listed items.

It is understandable that although the terms “first”, “second”, and “third” may be used in embodiments of the disclosure to describe various types of information, the information should not be limited to these terms. These terms are only used to distinguish the same type of information from each other. For example, without departing from the scope of the disclosure, the first information may also be referred to as the second information, and similarly, the second information may also be referred to as the first information. Depending on the context, the term “if” as used herein may be interpreted as “when”, “while” or “in response to determining”. For the purposes of brevity and ease of understanding, the terms “greater than” or “less than”, “higher than” or “lower than” are used herein to represent size relationships. Those skilled in the art understand that the term “greater than” also covers the meaning of “greater than or equal to” and the term “less than” also covers the meaning of “less than or equal to”, and the term “higher than” also covers the meaning of “higher than or equal to”, and the term “lower than” also covers the meaning of “lower than or equal to”.

In order to facilitate understanding, the terms involved in this disclosure will be introduced below.

### 1. Metasurface

Metamaterial is an artificial structure consisting of a number of sub-wavelength units arranged periodically. By changing the structure and arrangement of the units, many physical phenomenas that do not exist in nature can be created, such as inverse Doppler, negative refraction and inverse Cherenkov radiation. With the demand for highly integrated and low-profile metamaterials, the units can be arranged in a two-dimensional form on a plane to form a metasurface. Unlike the metamaterial that utilizes spatial phase accumulation to achieve phase control of the electromagnetic waves, the metasurface utilizes the phase and amplitude abrupt changes obtained when the incident electromagnetic wave reaches the surface of the unit to regulate the electromagnetic wave, which has the advantages of low profile and easy integration.

### 2. Anisotropy

Anisotropy is the property of a substance in which all or some of its chemical, physical or other properties change with direction, showing differences in different directions. Anisotropy is a common property in materials and media that varies greatly in scale. All of them are anisotropic, from crystals to a variety of materials used in daily life, and then to the Earth's mediums. It should be noted that anisotropy and inhomogeneity describe materials from two different perspectives and should not be equated.

In order to better understand a metasurface unit, a metasurface array antenna and a communication device thereof disclosed in the embodiment of the disclosure, a communication system to which the embodiment of the disclosure is applicable will be described below.

As illustrated in FIG. 1, FIG. 1 is a schematic diagram of a communication system provided by an embodiment of the disclosure. The communication system may include, but is not limited to, one network device and one terminal. The number and form of the devices illustrated in FIG. 1 are for illustrative purposes only and do not constitute a limitation on the embodiments of the disclosure, and two or more network devices and two or more terminals may be included in practical applications. The communication system illustrated in FIG. 1 includes, for example, a network device 101 and a terminal 102.

It is noteworthy that the technical solutions of embodiments of the disclosure may be applied to various communication systems, such as, a long term evolution (LTE) system, a 5th generation (5G) mobile communication system, a 5G new radio (NR) system, or other future new mobile communication systems. It should be noted that sidelink in the embodiments of the disclosure may also be referred to as side link or direct link.

The network device 101 in the embodiment of the disclosure is an entity on a network side for transmitting or receiving signals. For example, the network device 101 may be an evolved NodeB (eNB), a transmission reception point (TRP), a next generation NodeB (gNB) in a NR system, a base station in other future mobile communication systems, or an access node in a wireless fidelity (WiFi) system. The specific technology and specific form of the device adopted by the network device are not limited in the embodiment of the disclosure. The network device according to the embodiment of the disclosure may be composed of a central unit (CU) and distributed units (DUs). The CU may also be called a control unit. By using the CU-DU structure, a protocol layer of the network device, such as a base station, can be split, with some of the protocol layer functions placed in the CU for centralized control, and some or all of the remaining protocol layer functions distributed in the DUs, and the DUs are centrally controlled by the CU.

The terminal 102 in the embodiment of the disclosure is an entity on a user side for receiving or transmitting signals, such as a mobile phone. The terminal may also be referred to as a terminal, a user equipment (UE), a mobile station (MS), a mobile terminal (MT), and the like. The terminal may be a car with a communication function, a smart car, a mobile phone, a wearable device, a Pad, a computer with a wireless transceiver function, a virtual reality (VR) terminal, an augmented reality (AR) terminal, a wireless terminal in industrial control, a wireless terminal in self-driving, a wireless terminal in remote medical surgery, a wireless terminal in smart grid, a wireless terminal in transportation safety, a wireless terminal in smart city, a wireless terminal in smart home, etc. The specific technology and specific form of the device adopted by the terminal are not limited in the embodiment of the disclosure.

In sidelink communication, there are four sidelink transmission modes. Sidelink transmission mode 1 and sidelink transmission mode 2 are used for device-to-device (D2D) communication between terminals. Sidelink transmission mode 3 and sidelink transmission mode 4 are used for vehicle to everything (V2X) communication. When the sidelink transmission mode 3 is adopted, resource allocation is scheduled by the network device 101. In detail, the network device 101 sends resource allocation information to the terminal 102, and then the terminal 102 allocates resources to the other terminal, so that the other terminal can send information to the network device 101 through the allocated resources. In V2X communication, a terminal with a better signal or higher reliability can be used as the terminal 102. The first terminal mentioned in the embodiment of the disclosure may refer to the terminal 102, and the second terminal may refer to the other terminal.

It is understandable that the communication system is described in the embodiment of the disclosure to clearly illustrate the technical solution according to the embodiment of the disclosure, and does not constitute a limitation on the technical solution provided by the embodiment of the disclosure. Those skilled in the art understand that as system architectures evolve and new business scenarios emerge, the technical solution according to the embodiment of the disclosure is also applicable to similar technical problems.

A metasurface unit and a metasurface array antenna provided by the embodiment of the disclosure can be applied to the communication system shown in FIG. 1.

A metasurface unit, a metasurface array antenna and a communication device provided by the disclosure will be described in detail with the attached drawings.

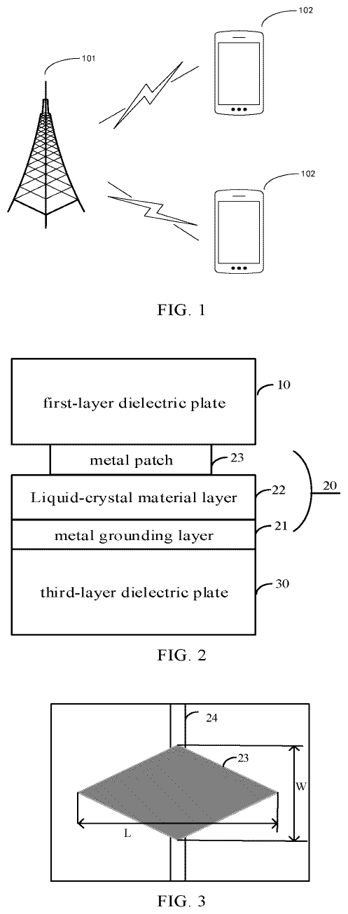

As illustrated in FIG. 2, FIG. 2 is a schematic diagram of a side view of a metasurface unit provided by an embodiment of the disclosure. As illustrated in FIG. 2, the metasurface unit 200 includes: a first-layer dielectric plate 10, a second-layer dielectric plate 20 and a third-layer dielectric plate 30. Optionally, the first-layer dielectric plate 10 is one surface of the metasurface unit 200, the third-layer dielectric plate 30 is the other surface of the metasurface unit 200. The two surfaces may be understood to be in a symmetrical relationship. For example, the first layer dielectric plate may be an upper surface of the metasurface unit 200, and the third layer dielectric plate 30 may be a lower surface of the metasurface unit 200. The second layer dielectric plate 20 is disposed between the first layer dielectric substrate 10 and the third layer dielectric plate 30. As illustrated in FIG. 2, the metasurface unit 200 includes: the first-layer dielectric plate 10, the second-layer dielectric plate 20 and the third-layer dielectric plate 30 from top to bottom. It should be noted that the description of “from top to bottom” in the embodiment of the disclosure is only for the convenience of explanation and cannot be used as a condition to limit the disclosure.

The second-layer dielectric plate 20 includes: a metal grounding layer 21, a liquid-crystal material layer 22, a metal patch 23 with anisotropic characteristics and a direct current (DC) bias line 24 (not shown in FIG. 2). In the embodiment of the disclosure, both the DC bias line 24 and the metal patch 23 are printed on the liquid crystal material layer 22. It should be noted that the liquid crystal material layer 22 is disposed between the first layer dielectric plate 10 and the metal grounding layer 21, and the metal grounding layer 21 is adjacent to the third-layer dielectric plate 30.

In the embodiment of the disclosure, by using liquid crystal as an adjustable material on the second-layer dielectric plate, the operating frequency band of the metasurface antenna can be extended to the millimeter wave frequency band or even terahertz frequency band, thereby expanding the operating frequency band of the array antenna.

Optionally, in the embodiment of the disclosure, the metal patch 23 with anisotropic characteristics may be in a shape of a rhombus, an ellipse or a rectangle, etc. The metasurface unit in the embodiment of the disclosure can reflect beams outwardly based on the metal patch 23. Due to the anisotropic characteristics of the patch used in the reflective metasurface unit, it is possible to construct a metasurface with dual-frequency operating capability by making the two polarization directions respectively operate at different frequency bands.

Optionally, the metal patch 23 serves as a positive terminal of DC bias voltage while serving as a scatterer, and the metal grounding layer 21 serves as a negative terminal of DC bias voltage while serving as a reflective surface.

Optionally, the first-layer dielectric plate 10 and the third-layer dielectric plate 30 may serve as supporters for the metasurface unit to provide a supporting function for the metasurface unit, and the first-layer dielectric plate 10 and the third-layer dielectric plate 30 can restrain the flow of liquid crystal in the second-layer dielectric plate 20. In some implementations, the first-layer dielectric plate 10 may be a glass dielectric substrate, and the third-layer dielectric plate 30 may be a glass dielectric plate. As illustrated in FIG. 3, FIG. 3 is a schematic diagram of a top view of a metasurface unit provided by an embodiment of the disclosure. As illustrated in FIG. 3, the DC bias line 24 and the metal patch 23 are both printed on the liquid-crystal material layer 22. That is, the bias line 24 and the metal patch 23 are in the same layer.

Optionally, the metal patch 23 may be a diamond-shaped metal patch having anisotropic characteristics. As illustrated in FIG. 3, the diamond-shaped metal patch 23 includes a first diagonal line L and a second diagonal line W, wherein the first diagonal line L may be a long diagonal line and the second diagonal line W may be a short diagonal line. That is, the length of the first diagonal line is greater than the length of the second diagonal line. In the embodiment of the disclosure, the change of the first diagonal line mainly affects the reflection amplitude and reflection phase of the first polarization wave, and the change of the second diagonal line mainly affects the reflection amplitude and reflection phase of the second polarization wave. That is, the first diagonal line is associated with the reflection amplitude and reflection phase of the first polarization beam, and the second diagonal line is associated with the reflection amplitude and reflection phase of the second polarization beam.

As illustrated in FIG. 3, the change of the first diagonal line affects the polarization wave in the X direction, and the change of the second diagonal line affects the polarization wave in the Y direction. Optionally, the polarization wave in the X direction is referred to as the first polarization wave, and the polarization wave in the Y direction is referred to as the second polarization wave in this disclosure. The above definitions are applicable to the following embodiments in this disclosure, and will not be explained again.

In the embodiment of the disclosure, a correspondence between different lengths of the diagonal lines and operating frequencies can be obtained in advance through testing. The center operating frequencies of the first polarization beam and the second polarization beam are determined according to the correspondence between the lengths of the diagonal lines and the operating frequencies. Optionally, based on the lengths of the first diagonal line and the second diagonal line, by querying the correspondence between the lengths of diagonal lines and the operating frequencies, the center operating frequencies of each of the first polarization beam and the second polarization beam are obtained.

It should be noted that, since the lengths of the first diagonal line and the second diagonal line are different, the determined center operating frequencies of the first polarization beam and the second polarization beam are different. In some implementations, the center operating frequencies of the first polarization beam and the second polarization beam are negatively correlated with lengths of respective diagonal lines. That is, if the length of the first diagonal line is greater than the length of the second diagonal line, the center operating frequency of the first polarization beam is less than the center operating frequency of the second polarization beam. If the length of the first diagonal line is less than the length of the second diagonal line, the center operating frequency of the first polarization beam is greater than the center operating frequency of the second polarization beam.

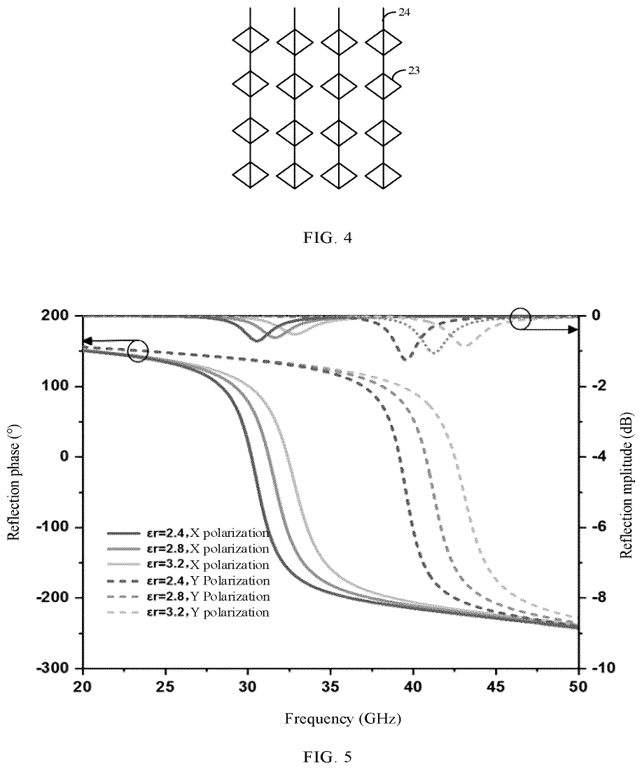

As illustrated in FIG. 4, FIG. 4 is a schematic diagram of an arrangement of metasurface units provided in an embodiment of the disclosure. In some implementations, a plurality of metasurface units are arranged in an array to form a metasurface array. In this array, the metal patches 23 in the metasurface units arranged in the same column are connected by the DC bias line 24. That is, the metasurface units in the same column can share the same DC bias line, and the line extend to the outermost layer to maximize the simulation of the DC feed routing in actual applications.

In the embodiment of the disclosure, the DC bias line 24 is used to control the metasurface units per entire column, thus reducing the complexity of feeding network. That is, the relative dielectric constant of the entire column can be changed through the DC bias line 24 of each column, so that the metasurface units can be switched to different states.

On the basis of the above embodiments, in the embodiment of the disclosure, the relative dielectric constant of liquid crystal in the liquid-crystal material layer 22 can be adjusted in the operating frequency band, so that the change in the relative dielectric constant of the liquid crystal with the change in the voltages at the two ends in the actual applications can be simulated. In the embodiment of the disclosure, the relative dielectric constant of the liquid crystal in the liquid-crystal material layer 22 can be adjusted by a simulation software. Through the simulation software, the numerical value of the relative dielectric constant can be flexibly set to change continuously, to conveniently obtain more accurate numerical results and avoid errors.

With the change of the relative dielectric constant of the liquid crystal material in the metasurface unit, the reflection amplitude and reflection phase of the metasurface unit also change. That is, by adjusting the relative dielectric constant of the liquid crystal material within the operating frequency band, the phase state of the metasurface unit in the embodiment of the disclosure will also change continuously. Optionally, during the process of adjusting the relative dielectric constant of the liquid crystal material within the operating frequency band, the metasurface unit may correspond two different phase states with a reflection phase difference of 180°.

In some implementations, plane waves with different polarization directions can be incident into the metasurface unit. For example, an incident plane wave with a first polarization direction, i.e., an incident wave with an X polarization direction can be incident into the metasurface unit, and an incident plane wave with a second polarization direction, i.e., an incident wave with a Y polarization direction can be incident into the metasurface unit. When plane waves with the same polarization direction are incident into the metasurface unit, the reflection amplitude and phase of the metasurface unit can be changed by adjusting the relative dielectric constant of the liquid crystal material. Based on the continuous adjustable character of the liquid crystal, the state of the metasurface unit can be continuously regulated by changing the voltage values loaded on the two sides of the liquid-crystal material layer.

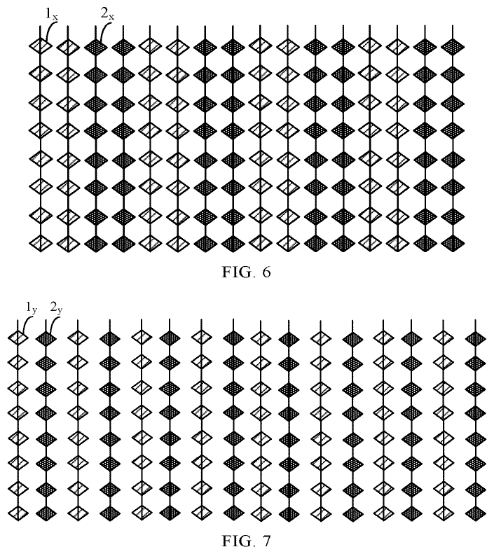

As the relative dielectric constant of the liquid crystal material in the metasurface unit changes, the simulation curves of the reflection amplitude and reflection phase of the metasurface unit as a function of frequency are shown in FIG. 5. It can be seen from FIG. 5 that in the case that the first polarization wave is incident into the metasurface unit as an incident plane wave, the center operating frequency of the metasurface unit is 31.5 GHz. When the relative dielectric constants of the liquid crystal material are εᵣ=2.4 and εᵣ=3.9, the phase state difference corresponding to the metasurface element is 180°. In case that the second polarization wave is incident on the metasurface unit as an incident plane wave, the center operating frequency of the metasurface unit is 42.2 GHz. When the relative dielectric constants of the liquid crystal material are εᵣ=2.4 and εᵣ=2.8, the corresponding phase state difference is 180°.

In the embodiment of the disclosure, in case that the incident plane wave is the first polarization wave, the metasurface units with two different phase states can be called a first metasurface unit 1x and a second metasurface unit 2x. In case that the incident plane wave is the second polarization wave, the metasurface units with two different phase states can be called a third metasurface unit 1y and a fourth metasurface unit 2y.

The metasurface units of the two different phase states are arranged in different arrangement. In the embodiment of the disclosure, the beams reflected from the incidence of plane incident wave for the different arrangements correspond to different phase cycles and beam deflection angles, thereby achieving the purpose of beam scanning through the reflection function of the metasurface unit.

In the embodiment of the disclosure, in case of the incident plane wave is the first polarization wave, the metasurface units with two different phase states can be called a first metasurface unit 1x and a second metasurface unit 2x. In case of the incident plane wave is the second polarization wave, the metasurface units with the two different phase states can be called a third metasurface unit 1y and a fourth metasurface unit 2y.

Optionally, in case of the first polarization wave is incident, the metasurface units can be arranged in four ways, i.e., “1x 1x 2x 2x 1x 1x 2x 2x 1x 1x 2x 2x 1x 1x 2x 2x”, “1x 1x 1x 2x 2x 2x 1x 1x 1x 2x 2x 2x 1x 1x 1x 2x”, “1x 1x 1x 1x 2x 2x 2x 2x 1x 1x 1x 1x 2x 2x 2x 2x” and “1x 1x 1x 1x 1x 2x 2x 2x 2x 2x 1x 1x 1x 1x 1x 2x”. It should be noted that each number in an array indicates the metasurface unit type in the entire corresponding column. For example, in “1x 1x 2x 2x 1x 1x 2x 2x 1x 1x 2x 2x 1x 1x 2x 2x”, the first 1x indicates that the first column is first metasurface unit, the second 1x indicates that the second column is first metasurface unit, the third 2x indicates that the third column is second metasurface unit, the fourth 2x indicates that the fourth column is second metasurface unit, and by analogy, the sixteenth 2x indicates that the sixteenth column is second metasurface unit.

For another example, if the metasurface units are arranged into “1x 1x 2x 2x 1x 1x 2x 2x 1x 1x 2x 2x 1x 1x 2x 2x” as shown in FIG. 6, the first column and the second column are the first metasurface units, the third column and the fourth column are the second metasurface units, the fifth column and the sixth column are the first metasurface units, the seventh column and the eighth column are the second metasurface units, and by analogy, the thirteenth column and the fourteenth column are the first metasurface units, and the fifteenth column and the sixteenth column are the second metasurface units.

Optionally, in case of the second polarization wave is incident, the metasurface units can be arranged in four ways, i.e., “1y 2y 1y 2y 1y 2y 1y 2y 1y 2y 1y 2y 1y 2y 1y 2y”, “1y 1y 2y 2y 1y 1y 2y 2y 1y 1y 2y 2y 1y 1y 2y 2y”, “1y 1y 1y 2y 2y 2y 1y 1y 1y 2y 2y 2y 1y 1y 1y 2y”, and “1y 1y 1y 1y 2y 2y 2y 2y 1y 1y 1y 1y 2y 2y 2y 2y”. It should be noted that each number in an array indicates the metasurface unit type in the entire corresponding column. For example, in “1y 2y 1y 2y 1y 2y 1y 2y 1y 2y 1y 2y 1y 2y 1y 2y”, the first 1y indicates that the first column is the third metasurface unit, the second 2y indicates that the second column is the fourth metasurface unit, the third 1y indicates that the third column is the third metasurface unit, the fourth 2y indicates that the fourth column is the fourth metasurface unit, and by analogy, the fifteenth 1y indicates that the fifteenth column is the third metasurface unit, and the sixteenth 2y indicates that the sixteenth column is the fourth metasurface unit.

For another example, if the metasurface units are arranged into “1y 2y 1y 2y 1y 2y 1y 2y 1y 2y 1y 2y 1y 2y 1y 2y” as shown in FIG. 7, the first column is the third metasurface unit, the second column is the fourth metasurface unit, the third column is the third metasurface unit, the fourth column is the fourth metasurface unit, and by analogy, the fifteenth 1y indicates that the fifteenth column is the third metasurface unit, and the sixteenth 2y indicates that the sixteenth column is the fourth metasurface unit.

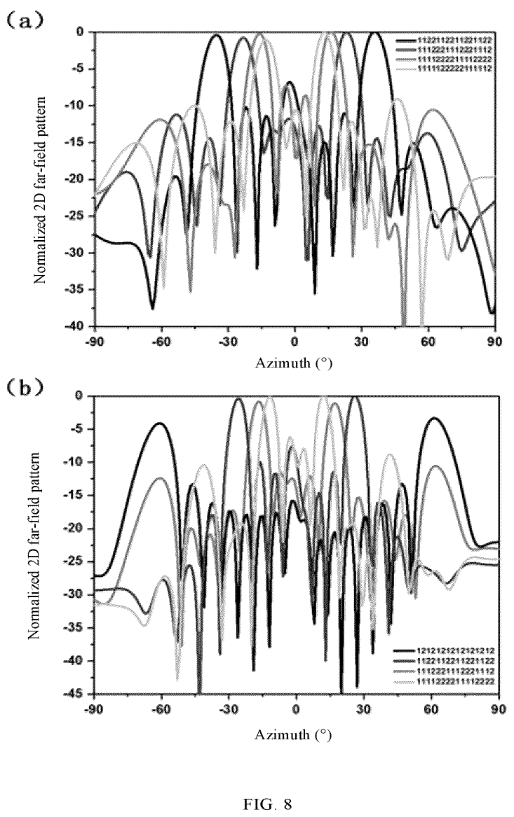

In the embodiment of the disclosure, since the metasurface units are arranged in different ways, the phase cycles of beams reflected by the metasurface units will change, and the beam deflection angles will change accordingly, thereby achieving the purpose of beam scanning. As illustrated in FIG. 8, near the low frequency of 31.5 GHz, the beam is scanned to 12.9°, 16°, 23°, and 35.4° respectively, and near the high frequency of 42.2 GHz, the beam is scanned to 11.5°, 16.5°, 25.4°, and 60° respectively. Near the two frequency points, the metasurface unit achieves the function of beam scanning.

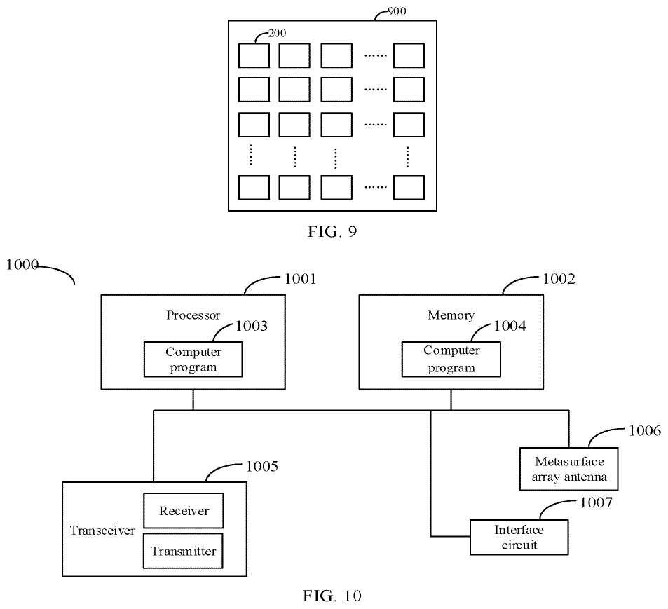

As illustrated in FIG. 9, FIG. 9 is a schematic diagram of a metasurface array antenna provided by an embodiment of the disclosure. As illustrated in FIG. 9, the metasurface array antenna 900 may include a plurality of metasurface units 200 in the above embodiment. In some implementations, the metasurface array antenna 900 may be an array of M×N, that is, it includes M×N metasurface units 200. M and N are positive integers greater than or equal to 1, M represents a row, and N represents a column.

In the embodiment of the disclosure, the metal patches 23 of the metasurface units 200 in the same column are connected by the DC bias line 24. That is, the metasurface units in the same column share the same DC bias line, which extend to the outermost layer, to simulate the DC feed routing in actual applications to the maximum extent. In the embodiment of the disclosure, the DC bias line 24 is used to control the metasurface units per entire column, thereby reducing the complexity of feeding network. In this way, the relative dielectric constant of an entire column can be changed through the DC bias line 24 of each column, so that the metasurface units can be switched between different states.

In the embodiment of the disclosure, the metasurface antenna array 900 may include metasurface units 900 with two different phase states, which are arranged in different ways to form different metasurface array antennas. For different arrangement, the beams reflected from metasurface antenna array under the incidence of plane incident waves correspond to different phase cycles and beam deflection angles. In the embodiment of the disclosure, if the incident plane wave is the first polarization wave, the metasurface units with the two different phase states can be called a first metasurface unit 1x and a second metasurface unit 2x. If the incident plane wave is the second polarization wave, the metasurface units with the two different phase states can be called a third metasurface unit 1y and a fourth metasurface unit 2y.

Optionally, if the first polarization wave is incident, the metasurface units can be arranged in four ways, i.e., “1x 1x 2x 2x 1x 1x 2x 2x 1x 1x 2x 2x 1x 1x 2x 2x”, “1x 1x 1x 2x 2x 2x 1x 1x 1x 2x 2x 2x 1x 1x 1x 2x”, “1x 1x 1x 1x 2x 2x 2x 2x 1x 1x 1x 1x 2x 2x 2x 2x” and “1x 1x 1x 1x 1x 2x 2x 2x 2x 2x 1x 1x 1x 1x 1x 2x”.

Optionally, when the second polarization wave is incident, the metasurface units can be arranged in four ways, i.e., “1y 2y 1y 2y 1y 2y 1y 2y 1y 2y 1y 2y 1y 2y 1y 2y”, “1y 1y 2y 2y 1y 1y 2y 2y 1y 1y 2y 2y 1y 1y 2y 2y”, “1y 1y 1y 2y 2y 2y 1y 1y 1y 2y 2y 2y 1y 1y 1y 2y”, and “1y 1y 1y 1y 2y 2y 2y 2y 1y 1y 1y 1y 2y 2y 2y 2y”.

In the embodiment of the disclosure, the metasurface units are arranged in different arrangements to form different metasurface array antennas, the phase cycles corresponding to the beams reflected by the array antennas will change, and the beam deflection angles will change accordingly, so that the purpose of beam scanning is achieved.

FIG. 10 is a schematic diagram of a communication device 1000 provided by an embodiment of the disclosure. The communication device 1000 may be a network device or a terminal. The communication device 1000 may include the metasurface array antenna in the above embodiment.

The communication device 1000 may include one or more processors 1001. The processor 1001 may be a general purpose processor or a dedicated processor, such as, a baseband processor or a central processor. The baseband processor is used for processing communication protocols and communication data. The central processor is used for controlling the communication device (e.g., base station, baseband chip, terminal, terminal chip, CU or DU), executing computer programs, and processing data of the computer programs.

Optionally, the communication device 1000 may include one or more memories 1002 on which a computer program 1004 may be stored. The processor 1001 executes the computer program 1004. Optionally, data may also be stored in the memory 1002. The communication device 1000 and the memory 1002 may be provided separately or may be integrated together.

Optionally, the communication device 1000 may also include a transceiver 1005 and a metasurface array antenna 1006. The transceiver 1005 may be referred to as transceiver unit, transceiver machine, or transceiver circuit, for realizing the transceiver function. The transceiver 1005 may include a receiver and a transmitter. The receiver may be referred to as receiver machine or receiving circuit, for realizing the receiving function. The transmitter may be referred to as transmitter machine or transmitting circuit, for realizing the transmitting function.

Optionally, the communication device 1000 may also include one or more interface circuits 1007. The interface circuits 1007 are used to receive code instructions and transmit the code instructions to the processor 1001. The processor 1001 runs the code instructions.

In an implementation, the processor 1001 may include a transceiver for implementing the receiving and transmitting functions. The transceiver may be, for example, a transceiver circuit, an interface, or an interface circuit. The transceiver circuit, interface, or interface circuit for implementing the receiving and transmitting functions may be separated or may be integrated together. The transceiver circuit, interface, or interface circuit described above may be used for code/data reading and writing, or may be used for signal transmission or delivery.

In an implementation, the processor 1001 may store a computer program 1003, which runs on the processor 1001. The computer program 1003 may be solidified in the processor 1001, in which case the processor 1001 may be implemented by hardware.

In an implementation, the communication device 1000 may include circuits. The circuits may implement the sending, receiving or communicating function in the preceding method embodiments. The processors and transceivers described in the disclosure may be implemented on integrated circuits (ICs), analog ICs, radio frequency integrated circuits (RFICs), mixed signal ICs, application specific integrated circuits (ASICs), printed circuit boards (PCBs), and electronic devices. The processors and transceivers can also be produced using various IC process technologies such as complementary metal oxide semiconductor (CMOS), nMetal-oxide-semiconductor (NMOS), positive channel metal oxide semiconductor (PMOS), bipolar junction transistor (BJT), bipolar CMOS (BiCMOS), silicon-germanium (SiGe), gallium arsenide (GaAs) and so on.

The communication device in the above description of embodiments may be a network device or a terminal (e.g., the first terminal in the above method embodiments), but the scope of the communication device described in the disclosure is not limited thereto, and the structure of the communication device may not be limited by FIG. 10. The communication device may be a stand-alone device or may be part of a larger device. For example, the described communication device may be:
(1) a stand-alone IC, chip, chip system or subsystem;
(2) a collection of ICs including one or more ICs, optionally, the collection of ICs may also include storage components for storing data and computer programs;
(3) an ASIC, such as a modem;
(4) modules that can be embedded within other devices;
(5) receivers, terminals, smart terminals, cellular phones, wireless devices, handheld machines, mobile units, in-vehicle devices, network devices, cloud devices, artificial intelligence devices, and the like; and
(6) others.

It is understandable by those skilled in the art that various illustrative logical blocks and steps listed in the embodiments of the disclosure may be implemented by electronic hardware, computer software, or a combination of both. Whether such function is implemented by hardware or software depends on the particular application and the design requirements of the entire system. Those skilled in the art may, for each particular application, use various methods to implement the described function, but such implementation should not be construed as being beyond the scope of protection of the embodiments of the disclosure.

Those skilled in the art understand that “first”, “second”, and other various numerical numbers involved in the disclosure are only described for the convenience of differentiation, and are not used to limit the scope of the embodiments of the disclosure, or indicate the order of precedence.

The term “at least one” in the disclosure may also be described as one or more, and the term “multiple” may be two, three, four, or more, which is not limited in the disclosure. In the embodiments of the disclosure, for a type of technical features, “first”, “second”, and “third”, and “A”, “B”, “C” and “D” are used to distinguish different technical features of the type, the technical features described using “first”, “second”, and “third”, and “A”, “B”, “C” and “D” do not indicate any order of precedence or magnitude.

Those skilled in the art may realize that the units and algorithmic steps of the various examples described in combination with the embodiments disclosed herein are capable of being implemented in the form of electronic hardware, or a combination of computer software and electronic hardware. Whether these functions are performed in the form of hardware or software depends on the specific application and design constraints of the technical solution. Those skilled in the art may use different methods to implement the described functions for each particular application, but such implementations should not be considered as beyond the scope of the disclosure.

It is clearly understood by those skilled in the field to which it belongs that, for convenience and brevity of description, the specific working processes of the systems, apparatuses, and units described above may be referred to the corresponding processes in the preceding method embodiments, and will not be repeated herein.

The above mentioned are only specific implementations of the disclosure, but the scope of protection of the disclosure is not limited thereto. Those skilled in the art that are familiar with the technical field can easily think of changes or substitutions within the technical scope disclosed in the disclosure, which shall be covered by the scope of protection of the disclosure. Therefore, the scope of protection of the disclosure shall be based on the scope of protection of the stated claims.

1. A metasurface unit, comprising:
a first-layer dielectric plate, a second-layer dielectric plate and a third-layer dielectric plate, wherein the second-layer dielectric plate comprises a metal grounding layer, a liquid-crystal material layer, a metal patch with anisotropic characteristics and a direct-current (DC) bias line, both the DC bias line and the metal patch are printed on the liquid-crystal material layer, the first-layer dielectric plate is one surface of the metasurface unit, the third-layer dielectric plate is the other surface of the metasurface unit, and the second-layer dielectric plate is disposed between the first-layer dielectric plate and the third-layer dielectric plate.

2. The metasurface unit of claim 1, wherein metal patches in the same column are connected by the DC bias line.

3. The metasurface unit of claim 1, wherein the metal patch acts a positive terminal of DC bias voltage while serving as a scatterer, and the metal grounding layer acts as a negative terminal of the DC bias voltage while serving as a reflective surface.

4. The metasurface unit of claim 1, wherein the metal patch is a diamond-shaped metal patch, the diamond-shaped metal patch comprises a first diagonal line and a second diagonal line, the first diagonal line is related to a reflection amplitude and a reflection phase of a first polarization beam, and the second diagonal line is related to a reflection amplitude and a reflection phase of a second polarization beam.

5. The metasurface unit of claim 4, wherein center operating frequencies of the first polarization beam and the second polarization beam are different, and the center operating frequencies of the first polarization beam and the second polarization beam are negatively correlated with lengths of respective diagonal lines.

6. The metasurface unit of claim 5, wherein a relative dielectric constant of the liquid-crystal material is adjusted within an operating frequency band, and a phase state of the metasurface unit changes continuously.

7. The metasurface unit of claim 6, wherein the relative dielectric constant of the liquid-crystal material is adjusted within the operating frequency band, and the metasurface unit corresponds two different phase states having a reflection phase difference of 180°.

8. The metasurface unit of claim 7, wherein metasurface units with the two different phase states are arranged in different arrangements, and in a case of an incidence of an incident plane wave, beams reflected from the metasurface units in the different arrangements correspond to different phase cycles and beam deflection angles.

9. The metasurface unit of claim 8, wherein in case where the incident plane wave is the first polarization wave, the metasurface units with the two different phase states comprise a first metasurface unit and a second metasurface unit, or in case where the incident plane wave is the second polarization wave, the metasurface units with the two different phase states comprise a third metasurface unit and a fourth metasurface unit.

10. The metasurface unit of claim 1, wherein the third-layer dielectric plate comprises a glass dielectric plate, and the first-layer dielectric plate is a glass dielectric substrate.

11. A metasurface array antenna, comprising M×N metasurface units, wherein M and N are positive integers greater than or equal to 1, and
wherein the metasurface unit comprises a first-layer dielectric plate, a second-layer dielectric plate and a third-layer dielectric plate, wherein the second-layer dielectric plate comprises a metal grounding layer, a liquid-crystal material layer, a metal patch with anisotropic characteristics and a direct-current (DC) bias line, both the DC bias line and the metal patch are printed on the liquid-crystal material layer, the first-layer dielectric plate is one surface of the metasurface unit, the third-layer dielectric plate is the other surface of the metasurface unit, and the second-layer dielectric plate is disposed between the first-layer dielectric plate and the third-layer dielectric plate.

12. The metasurface array antenna of claim 11, wherein the metasurface array antenna is under control per entire column.

13. The metasurface array antenna of claim 12, wherein the metasurface array antenna comprises metasurface units with two different phase states, the metasurface units with the two different phase states are arranged in different arrangements to form different metasurface array antennas, and in case of an incidence of an incident plane wave, beams reflected from the metasurface array antennas in the different arrangements correspond to different phase cycles and beam deflection angles.

14. A communication device comprising the metasurface array antenna, wherein the metasurface array antenna comprises M×N metasurface units,
wherein M and N are positive integers greater than or equal to 1, and
wherein the metasurface unit comprises a first-layer dielectric plate, a second-layer dielectric plate and a third-layer dielectric plate, wherein the second-layer dielectric plate comprises a metal grounding layer, a liquid-crystal material layer, a metal patch with anisotropic characteristics and a direct-current (DC) bias line, both the DC bias line and the metal patch are printed on the liquid-crystal material layer, the first-layer dielectric plate is one surface of the metasurface unit, the third-layer dielectric plate is the other surface of the metasurface unit, and the second-layer dielectric plate is disposed between the first-layer dielectric plate and the third-layer dielectric plate.

15. The communication device of claim 14, wherein the metasurface array antenna is under control per entire column.

16. The communication device of claim 14, wherein the metasurface array antenna comprises metasurface units with two different phase states, the metasurface units with the two different phase states are arranged in different arrangements to form different metasurface array antennas, and in case of an incidence of an incident plane wave, beams reflected from the metasurface array antennas in the different arrangements correspond to different phase cycles and beam deflection angles.

17. The metasurface array antenna of claim 11, wherein metal patches in the same column are connected by the DC bias line.

18. The metasurface array antenna of claim 11, wherein the metal patch acts a positive terminal of DC bias voltage while serving as a scatterer, and the metal grounding layer acts as a negative terminal of the DC bias voltage while serving as a reflective surface.

19. The metasurface array antenna of claim 11, wherein the metal patch is a diamond-shaped metal patch, the diamond-shaped metal patch comprises a first diagonal line and a second diagonal line, the first diagonal line is related to a reflection amplitude and a reflection phase of a first polarization beam, and the second diagonal line is related to a reflection amplitude and a reflection phase of a second polarization beam.

20. The metasurface array antenna of claim 11, wherein center operating frequencies of the first polarization beam and the second polarization beam are different, and the center operating frequencies of the first polarization beam and the second polarization beam are negatively correlated with lengths of respective diagonal lines.
